(19) United States
(12) Patent Application Publication
(10) Pub. No.: US 2015/0124039 A1
(43) Pub. Date: May 7, 2015

(54) SCAN-LINE ADJUSTING DEVICE, OPTICAL SCANNING DEVICE, AND IMAGE FORMING APPARATUS

(71) Applicant: Daisuke YOSHIDA, Kanagawa (JP)

(72) Inventor: Daisuke YOSHIDA, Kanagawa (JP)

(21) Appl. No.: 14/522,751

(22) Filed: Oct. 24, 2014

(30) Foreign Application Priority Data
Nov. 6, 2013 (JP) 2013-229997

(51) Int. Cl. B41J 2/385

(52) U.S. Cl. CPC G03G 15/043
USPC 347/118

(57) ABSTRACT

A scan-line adjusting device includes a first biasing unit which applies a first biasing force in biasing direction to a longitudinal one end of an optical unit, a second biasing unit which applies a second biasing force in the biasing direction to a longitudinal other end of the optical unit, a support unit which supports the optical unit at a position between a position where the first biasing force is applied and a position where the second biasing force is applied while allowing the optical unit to pivot against the biasing force, a position limiter which limits a position of the longitudinal one end against the first biasing force and can change the position in the biasing direction, and a vibration damping member which damps vibration transmitted from the second biasing unit to the optical unit.

### CROSS-REFERENCE TO RELATED APPLICATIONS

The present application claims priority to and incorporates by reference the entire contents of Japanese Patent Application No. 2013-229997 filed in Japan on Nov. 6, 2013.

### BACKGROUND OF THE INVENTION

1. Field of the Invention

The present invention relate to a scan-line adjusting device, an optical scanning device, and an image forming apparatus.

2. Description of the Related Art

An image forming apparatus, such as a copier, a printer, or a facsimile is well known to include an optical scanning device configured to form a latent image on a latent image bearer, such as a photoconductive drum, by optically scanning the latent image bearer with a light beam which is emitted according to image information. The optical scanning device for performing the optical scanning typically includes a light source such as a laser diode, a deflector including a polygon mirror or the like, a scanning lens (fθ lens), an elongated lens, and a reflecting mirror.

A more-than-negligible assembly error can occur in optical components and support members which make up the optical scanning device configured as described above. Such an assembly error or the like can cause a scan line which scans the surface of the latent image bearer to tilt relative to a moving direction of the surface of the latent image bearer.

Japanese Patent No. 4951242 describes an optical scanning device including a scan-line adjusting device which adjusts a tilt of a scan line.

FIG. 14 is a diagram illustrating the scan-line adjusting device described in Japanese Patent No. 4951242.

The scan-line adjusting device, which is arranged on an optical path of the optical scanning device, adjusts the scan line tilt by adjusting an orientation of an elongated lens unit 250, which serves as an optical unit, including an elongated lens 251 and a bracket 252 which holds the elongated lens 251.

A first flat spring 261 serving as a first biasing unit applies a biasing force to one end of a top surface of the elongated lens unit 250 in direction toward a fulcrum 266. A second flat spring 262 serving as a second biasing unit applies a biasing force to the other end of the top surface of the elongated lens unit 250 in the same direction (downward and upward in FIG. 14) as that of the first flat spring 261.

The scan-line adjusting device includes the fulcrum 266 which is a semicircular columnar support unit projecting from an optical housing 400 in which optical components and the optical unit of the optical scanning device are housed. The scan-line adjusting device brings a longitudinal center portion of a bottom surface of the elongated lens 251 into contact with the fulcrum 266 to support the elongated lens unit 250 in a manner that allows the elongated lens unit 250 to pivot on the fulcrum 266 within a predetermined range.

The scan-line adjusting device includes a skew adjusting mechanism, which serves as a position limiter, including a drive motor 256, an adjuster 258, and a motor holder 257 which holds the drive motor 256. The adjuster 258 is fixed onto a thread of a rotary shaft of the drive motor 256 by screwing. The adjuster 258 has a D-shaped cross section and inserted into a D-shaped adjuster inserting slot defined in the drive motor holder 257. A top portion of the adjuster 258 projects out from the adjuster inserting slot into contact with the bracket 252, thereby limiting a position of a longitudinal one end of the elongated lens unit 250.

The elongated lens unit 250 is sandwiched and held between the flat springs 261 and 262, and the adjuster 258 and the fulcrum 266.

A scan line tilt is adjusted by driving the drive motor 256. When the drive motor 256 is driven to rotate the rotary shaft, the adjuster 258 ascends or descends relative to the rotary shaft of the drive motor 256. Ascending or descending motion of the adjuster 258 relative to the rotary shaft of the drive motor 256 moves the longitudinal one end of the elongated lens unit 250 upward or downward in FIG. 14, which is the biasing direction of the first flat spring. More specifically, as the adjuster 258 ascends, the motor side end of the elongated lens unit 250 ascends against the biasing force applied from the first flat spring 261, and the position of the motor-side end that is limited by the adjuster 258 ascends. As a result, the elongated lens unit 250 changes its orientation by pivoting clockwise in FIG. 14 on the fulcrum 266. On the other hand, as the adjuster 258 descends, the motor-side end of the elongated lens unit 250 is lowered by the biasing force applied from the first flat spring 261, and the position of the motor-side end that is limited by the adjuster 258 descends. As a result, the elongated lens unit 250 changes its orientation by pivoting counterclockwise in FIG. 14 on the fulcrum 266. The scan line tilt is adjusted by adjusting the orientation of the elongated lens unit 250 in this manner.

However, the conventional technology has the following disadvantage. Each of components in an image forming apparatus where an optical scanning device is mounted can vibrate at its natural frequency when an impact is applied when, for example, an intermediate transfer belt is brought into contact with or separated from a photoconductive drum or when a paper feeding roller is brought into contact with a paper bundle on a paper feeding cassette during paper conveyance. Vibrations of the components in the image forming apparatus are transmitted to the elongated lens unit 250, which is the optical unit, via the optical housing 400. Among the transmitted vibrations of the components, vibration whose frequency is close to the natural frequency of the elongated lens unit 250, which is the optical unit, triggers resonance in the elongated lens unit 250, resulting in banding in a formed image.

Under the circumstances, there is a need for a scan-line adjusting device, an optical scanning device, and an image forming apparatus configured to reduce vibrations of an optical unit.

### SUMMARY OF THE INVENTION

It is an object of the present invention to at least partially solve the problems in the conventional technology. The present invention provides a scan-line adjusting device that includes a first biasing unit configured to apply a first biasing force in biasing direction to a longitudinal one end of an optical unit arranged on an optical path from a light source to a to-be-scanned subject; a second biasing unit configured to apply a biasing force in the biasing direction to a longitudinal other end of the optical unit, the biasing direction being same as that of the first biasing unit; a support unit configured to support the optical unit at a position between, in the longitudinal direction of the optical unit, a position where the biasing force is applied from the first biasing unit and a position where the biasing force is applied from the second biasing unit in a manner that allows the optical unit to pivot against the biasing force applied from the biasing unit; a position limiter configured to limit a position of the longitudinal one end of the optical unit against the biasing force applied from the first biasing unit to a limit position and be capable of changing the limit position of the longitudinal one end of the optical unit in the biasing direction of the first biasing unit; and a vibration damping member configured to damp vibration transmitted from the second biasing unit to the optical unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating relevant elements of a color printer according to an embodiment of the present invention;

FIG. 2 is a schematic diagram illustrating a layout of an incident optical system of a Bk-C unit which is an optical scanning device of the color printer;

FIG. 3 is an explanatory diagram of a polarizing beam splitter of the incident optical system;

FIG. 4 is a schematic diagram illustrating a layout of a scanning optical system of the Bk-C unit;

FIG. 5 is a schematic diagram illustrating a structure of a deflector as viewed along a rotation axis of rotating polygon mirrors of the Bk-C unit;

FIG. 6 is a bottom perspective view of a light source unit of the Bk-C unit;

FIG. 7 is a schematic top view of an optical path in the light source unit;

FIG. 8 is a perspective view of a scan-line adjusting device;

FIG. 9 is a front view of the scan-line adjusting device;

FIGS. 10A and 10B are a perspective view and a cross-sectional view of a skew adjusting mechanism, respectively;

FIG. 11 is an enlarged view of a longitudinal other end portion of the scan-line adjusting device;

FIG. 12 is an enlarged view of a longitudinal one end portion of the scan-line adjusting device;

FIG. 13 is a diagram illustrating an example of a surface-emitting light source; and

FIG. 14 is a diagram illustrating a conventional scan-line adjusting device.

### DETAILED DESCRIPTION OF THE PREFERRED EMBODIMENTS

Exemplary embodiments of a color printer as an image forming apparatus using an optical scanning device according to the present invention are described in detail below with reference to the accompanying drawings.

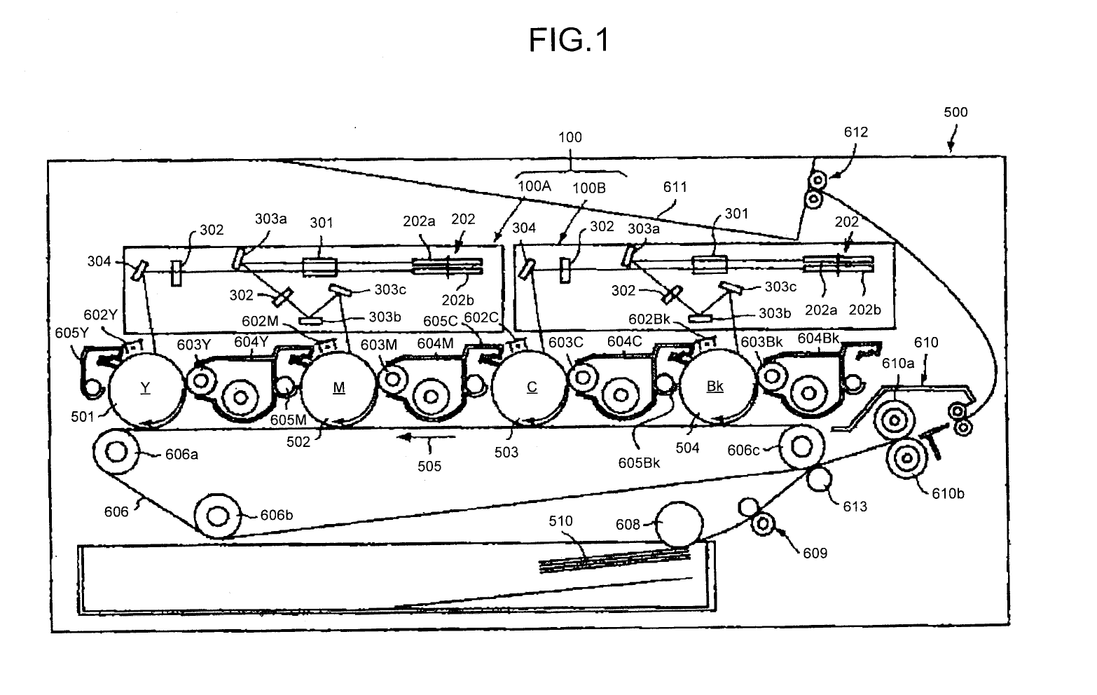

FIG. 1 is a schematic diagram illustrating relevant elements of a color printer 500 according to a present embodiment.

The color printer 500 is a tandem multiple-color printer capable of forming a full-color image by overlaying four color toner images such as black, cyan, magenta, and yellow images on one another. The color printer 500 includes an optical scanning device 100 and four photoconductive drums 501, 502, 503, and 504. The color printer 500 further includes four cleaning units 605Y, 605M, 605C, and 605Bk and four charging devices denoted by 602Y, 602M, 602C, and 602Bk. The color printer 500 further includes four developing devices denoted by 604Y, 604M, 604C, and 604Bk including developing rollers 603Y, 603M, 603C, and 603Bk, respectively. The color printer 500 further includes an intermediate transfer belt 606 which is an intermediate transfer member, a secondary transfer belt 613, a fixing device 610, a paper feeding roller 608, a pair of registration rollers 609, a paper discharging roller 612, and a paper discharging tray 611.

The photoconductive drum 501, the cleaning unit 605Y, the charging device 602Y, the developing roller 603Y, and the developing device 604Y make up an image station (hereinafter, “Y station”) for forming yellow images. The photoconductive drum 502, the cleaning unit 605M, the charging device 602M, the developing roller 603M, and the developing device 604M make up an image station (hereinafter, “M station”) for forming magenta images. The photoconductive drum 503, the cleaning unit 605C, the charging device 602C, the developing roller 603C, and the developing device 604C make up an image station (hereinafter, “C station”) for forming cyan images. The photoconductive drum 504, the cleaning unit 605Bk, the charging device 602Bk, the developing roller 603Bk, and the developing device 604Bk make up an image station (hereinafter, “K station”) for forming black images.

Each of the photoconductive drums 501, 502, 503, and 504 includes a photoconductor layer on its peripheral surface and is driven to rotate in a direction indicated by a corresponding one of arrows of FIG. 1 by a rotation mechanism (not shown). Each of the charging devices 602Y, 602M, 602C, and 602Bk uniformly charges the surface of a corresponding one of the photoconductive drums 501, 502, 503, and 504.

The optical scanning device 100 is made up of an M-Y unit 100A configured to perform exposure scanning of the photoconductive drum 501 for yellow and the photoconductive drum 502 for magenta and a Bk-C unit 100B configured to perform exposure scanning of the photoconductive drum 503 for cyan and the photoconductive drum 504 for black. The optical scanning device 100 irradiates each of to-be-scanned surfaces, which are the surfaces of the photoconductive drums, with scanning light which is on-off controlled according to image information, thereby forming electrostatic latent images on the surfaces of the photoconductive drums. The thus-formed electrostatic latent images are conveyed by rotation of the photoconductive drums 501, 502, 503, and 504 to developing areas where the electrostatic latent images respectively face the developing rollers of the developing devices 604Y, 604M, 604C, and 604Bk.

Each of the developing devices 604Y, 604M, 604C, and 604Bk includes the developing roller which carries charged toner thereon. A predetermined developing bias is applied to the developing roller. The toner on the developing roller is attracted and sticks to the electrostatic latent image on the photoconductive drum by action of a developing electric field produced by the predetermined developing bias. Images with the toners sticking thereto (hereinafter, “toner images”) are thus formed on the photoconductive drums 501, 502, 503, and 504.

The thus-formed toner images are conveyed by rotation of the photoconductive drums 501, 502, 503, and 504 to primary transfer areas where the toner images respectively face the intermediate transfer belt 606. The yellow, magenta, cyan, and black toner images on the photoconductive drums 501, 502, 503, and 504 are transferred one by one onto the intermediate transfer belt 606 at timing that overlays the toner images on one another. A multiple-color image is formed on the intermediate transfer belt 606 in this manner. Each of the cleaning units 605Y, 605M, 605C, and 605Bk removes transfer-residual toner left on, rather than being transferred from, the surface of a corresponding one of the photoconductive drums 501, 502, 503, and 504.

The paper feeding roller 608 picks up recording paper 510 and conveys the recording paper 510 to the pair of registration rollers 609 one sheet by one sheet. The pair of registration rollers 609 delivers the recording paper 510 at predetermined timing toward a secondary transfer area where the intermediate transfer belt 606 and the secondary transfer belt 613 face each other. The multiple-color toner image on the intermediate transfer belt 606 is secondarily transferred onto the recording paper 510 at this secondary transfer area. The recording paper 510, onto which the multiple-color toner image has been transferred, is thereafter delivered to the fixing device 610. The fixing device 610 applies heat and pressure onto the toner image on the recording paper 510, thereby fixing the toner image onto the recording paper. The recording paper 510, onto which the toner image has been fixed, is discharged via the paper discharging roller 612 onto the paper discharging tray 611.

A structure and operation of the optical scanning device 100 are described below.

The M-Y unit 100A and the Bk-C unit 100B making up the optical scanning device 100 are basically identical in structure. Accordingly, the structure and operation of the optical scanning device 100 are described below by way of example of the Bk-C unit 100B. In the description given below, Y, M, C, and Bk, each of which is a reference symbol representing a color, is omitted as appropriate.

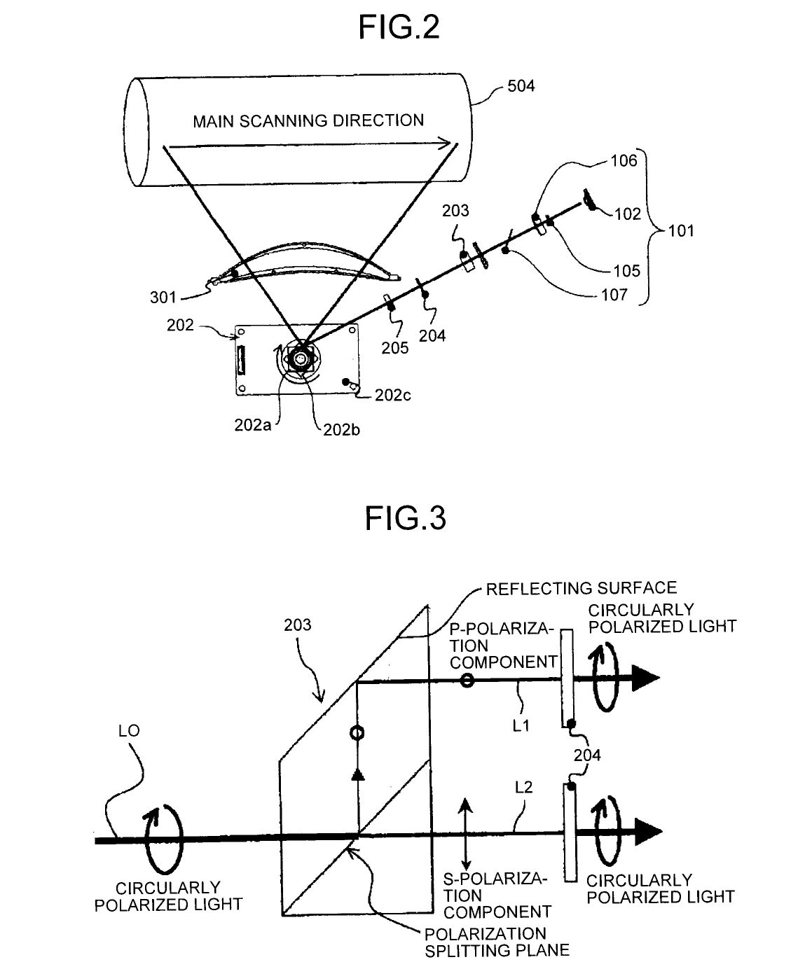

FIG. 2 is a schematic diagram illustrating a layout of an incident optical system of the Bk-C unit 100B.

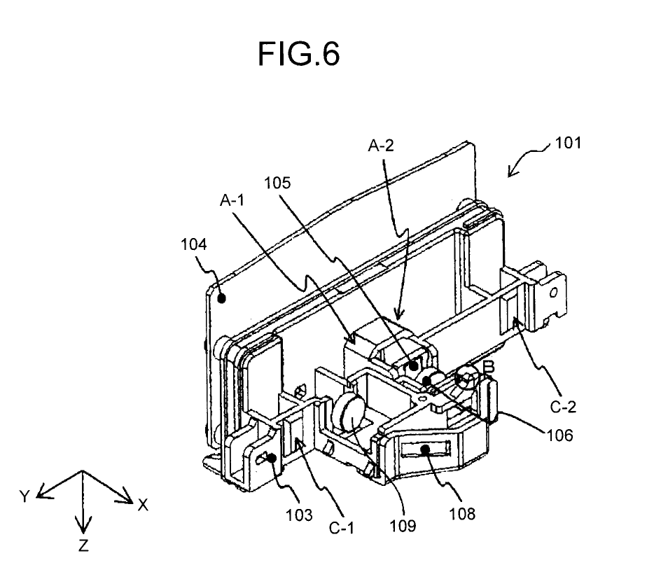

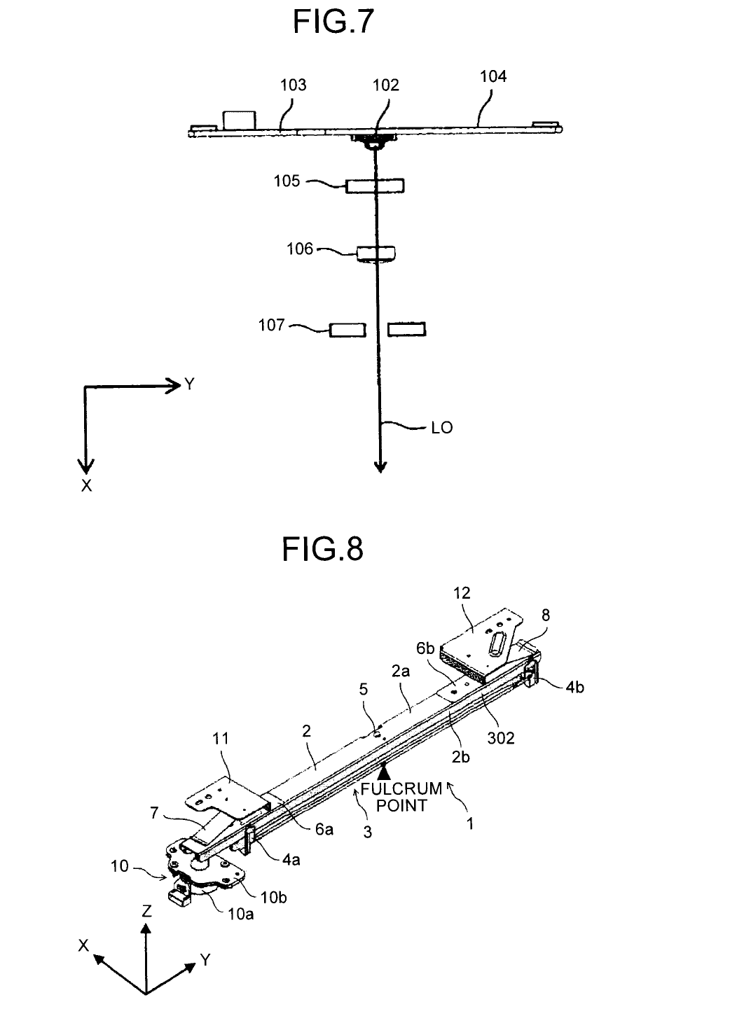

A light source unit 101, which is a light source device, includes a light source 102 configured to emit a laser beam which is linearly polarized light and a quarter-wave plate 105 configured to convert the laser beam emitted from the light source 102 into circularly polarized light. The light source unit 101 further includes a collimator lens 106 configured to collimate the laser beam, which is converted into the circularly polarized light by the quarter-wave plate 105, and an aperture 107 which limits the laser beam collimated by the collimator lens 106. The optical components 102, 105, 106, and 107 are positioned at predetermined locations relative to a light source holder 103 (see FIG. 6 or FIG. 7, for example), which will be described later, and assembled in one piece with the light source holder 103. The laser beam emitted from the light source unit 101 is incident on a deflector 202, which serves as a light deflection unit, via the incident optical system.

The incident optical system includes a polarizing beam splitter (PBS) 203 configured to split the laser beam emitted from the light source unit 101 into two laser beams L1 and L2 in the sub-scanning direction (the longitudinal front-back direction in the plane of FIG. 2). The incident optical system further includes a quarter-wave plate 204 configured to convert polarization characteristics of the two split laser beams L1 and L2 from linearly polarized light to circularly polarized light. The incident optical system further includes a cylindrical lens 205 configured to focus the laser beams L1 and L2 converted into the circularly polarized light onto mirror surfaces of two rotating polygon mirrors 202a and 202b mounted on the deflector 202. The cylindrical lens 205 has a function of condensing the laser beams converted into circularly polarized light only in the sub-scanning direction.

Each of the laser beams L1 and L2 is formed to a predetermined profile by the incident optical system configured as such. The laser beams L1 and L2 are then respectively focused on the mirror surfaces of the rotating polygon mirrors 202a and 202b of the deflector 202. The deflector 202 drives the rotating polygon mirrors 202a and 202b stably at a predetermined number of rotations about a rotation axis, which is parallel to the sub-scanning direction, of the polygon mirrors 202a and 202b. The laser beams L1 and L2 incident on the mirror surfaces of the rotating polygon mirrors 202a and 202b rotating in this manner are scanned in the main-scanning direction as illustrated in FIG. 2.

FIG. 3 is an explanatory diagram of the PBS 203.

The quarter-wave plate 105 in the light source unit 101 converts a laser light LO emitted from the light source unit 101 from linearly polarized light to circularly polarized light. When the laser beam LO having the polarization characteristics of circularly polarized light reaches a polarization splitting plane of the PBS 203, among polarization components of the circularly polarized light, only a component (s-polarization component) orthogonal to the plane of incidence on the mirror surface of the rotating polygon mirror 202a, 202b passes through the polarization splitting plane. Accordingly, the laser beam L2 including only the s-polarization component travels toward the lower rotating polygon mirror 202b. By contrast, among the polarization components of the circularly polarized light, a component (p-polarization component) parallel to the plane of incidence on the mirror surface of the rotating polygon mirror 202a, 202b is reflected from the polarization splitting plane. Thereafter, the laser beam L1 including only the p-polarization component travels toward the upper rotating polygon mirror 202a. At this point in time, the two split laser beams L1 and L2 differ from each other in polarization characteristics. However, each of the laser beams L1 and L2 is converted by the quarter-wave plate 204 back to circularly polarized light.

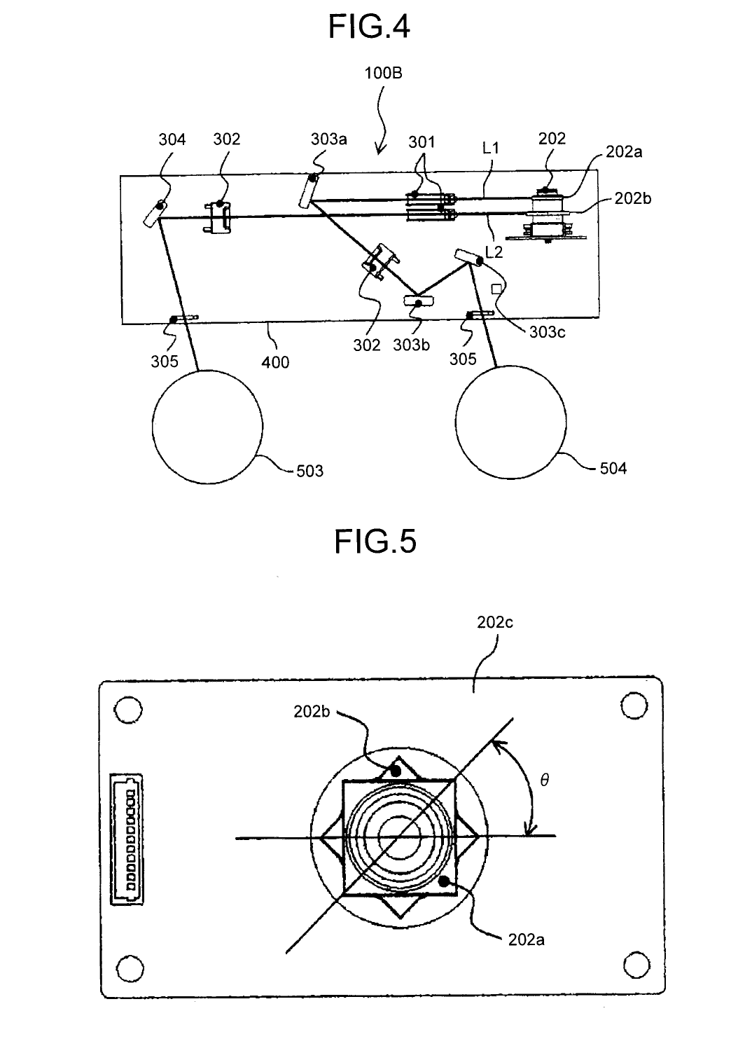

FIG. 4 is a schematic diagram illustrating a layout of a scanning optical system of the Bk-C unit 100B.

The laser beam L1 (the laser beam scanned by the mirror surface of the upper rotating polygon mirror 202a), which is one of the laser beams scanned by the deflector 202, passes through one of scanning lenses 301 and one of elongated lenses 302, and thereafter passes through one of dust-proof glasses 305. The laser beam L1 is scanned at a constant velocity across the surface of the photoconductive drum 504. Arranged on this optical path are mirrors 303a, 303b, and 303c for folding the laser beam L1. The laser beam L2 (the laser beam scanned by the mirror surface of the lower rotating polygon mirror 202b), which is the other one of the laser beams scanned by the deflector 202, passes through the other one of the scanning lenses 301 and the other one of the elongated lenses 302, and thereafter passes through the other one of the dust-proof glasses 305. The laser beam L2 is scanned at a constant velocity across the surface of the photoconductive drum 503. Arranged on this optical path is a mirror 304 for folding the laser beam L2.

Each of the incident optical system, the deflector 202, and the scanning optical system is fixed integrally to the optical housing 400 serving as a light-source support member illustrated in FIG. 4 with the optical housing 400 to thereby reliably provide a function as the optical scanning device.

FIG. 5 is a schematic diagram illustrating a structure of the deflector 202 as viewed along the rotation axis of the rotating polygon mirrors 202a and 202b.

In the deflector 202, the two rotating polygon mirrors denoted by 202a and 202b are configured integrally and assembled onto a motor circuit board 202C. Each of the rotating polygon mirrors 202a and 202b includes four mirror surfaces. The rotating polygon mirrors 202a and 202b are arranged in such a manner that the mirror surfaces of the upper rotating polygon mirror 202a and those of the lower rotating polygon mirror 202b are displaced by an angle θ in a rotating direction. In the present embodiment, the angle θ is 45 degrees. The upper rotating polygon mirror 202a is used to scan the photoconductive drum 504, while the lower rotating polygon mirror 202b is used to scan the photoconductive drum 503. The arrangement described above geometrically prevents simultaneous scanning by the upper and lower rotating polygon mirrors 202a and 202b.

FIG. 6 is a bottom perspective view of the light source unit 101.

FIG. 7 is a schematic top view of an optical path in the light source unit 101.

In the description below, for the sake of convenience, it is assumed that the X axis runs in the direction (direction of the optical axis) in which the laser beam is emitted, the Y axis runs along the main-scanning direction, and the Z axis runs along the sub-scanning direction. The light source unit 101 includes the light source 102, the quarter-wave plate 105, the collimator lens 106, and the aperture 107. The light source 102 is mounted on a laser-modulation circuit board 104.

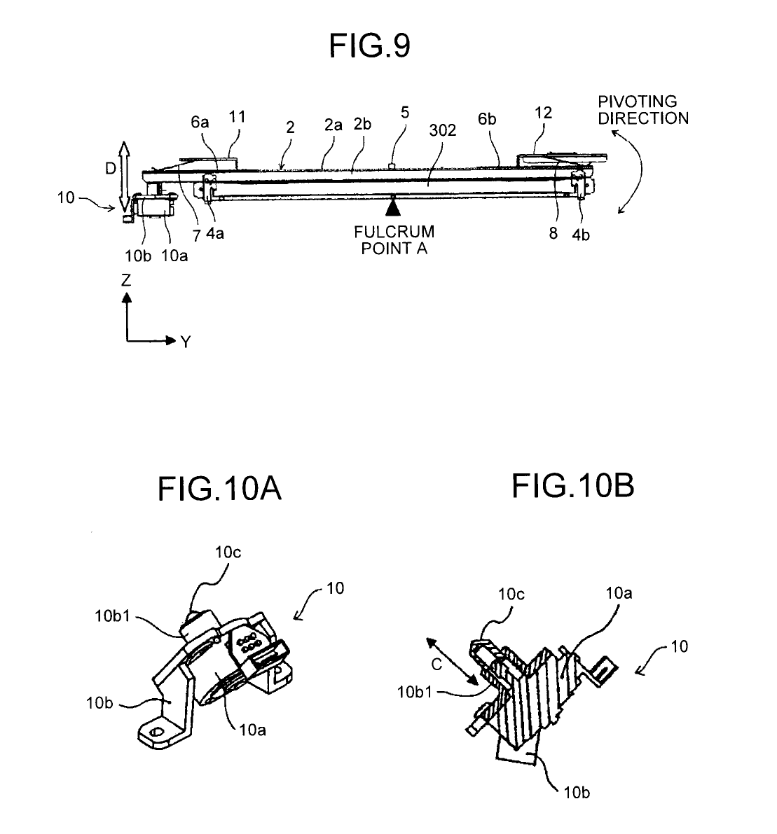

FIG. 8 is a perspective view of a scan-line adjusting device 1. FIG. 9 is a front view of the scan-line adjusting device.

The scan-line adjusting device 1 includes an elongated lens unit 3. The elongated lens unit 3 includes the elongated lens 302 serving as an optical component which corrects facet tilt error of the rotating polygon mirror 202a, 202b and a bracket 2 serving as a holding member which holds the elongated lens 302. The bracket 2 is formed of a sheet metal and includes a top surface portion 2a where the bracket 2 faces the top surface of the elongated lens 302 and side surfaces 2b formed by folding opposite ends in the X direction of the top surface portion 2a downward in FIG. 8. Fixing members 4a and 4b, each of which has a U-shape with angled corners, for fixing the elongated lens 302 to the bracket 2 are attached to the side surfaces 2b of the bracket 2 at positions corresponding to the longitudinal opposite ends of the elongated lens 302. A threaded hole is provided in the bracket 2 at a position corresponding to a center in the longitudinal direction (main-scanning direction) of the elongated lens 302. A curvature adjusting screw 5 is fixed into the threaded hole by screwing. The elongated lens 302 is fixed to the bracket 2 by pressing the elongated lens 302 downward in FIGS. 8 and 9 using the curvature adjusting screw 5, thereby pressing the opposite ends of the elongated lens 302 against the fixing members 4a and 4b.

Turning the curvature adjusting screw 5 to further press the elongated lens 302 downward causes the elongated lens 302 to curve and a scan line curvature to be adjusted. More specifically, the scan line curvature is corrected by turning the curvature adjusting screw 5 using an adjustment jig (not shown) while monitoring scan line characteristics (scan line curvature).

Smooth-surface members 6a and 6b, each of which is formed of a metal material, are arranged at longitudinal opposite ends of a surface, which is on the side opposite from an elongated-lens facing surface, of the top surface portion 2a of the bracket 2. A first flat spring 7 serving as a first biasing unit and a second flat spring 8 serving as a second biasing unit are in contact with smooth surfaces of the smooth-surface members 6a and 6b respectively.

The first flat spring 7 is fixed to a first-spring fixing member 11 fixed to the optical housing 400. The second flat spring 8 is fixed to a second-spring fixing member 12 fixed to the optical housing 400. The first flat spring 7 and the second flat spring 8 are biased in a vertical direction and the bias is upward. Accordingly, the elongated lens unit 3 receives a downward pressing force due to the downward biasing forces applied from the first flat spring 7 and the second flat spring 8.

A fulcrum (not shown) which contacts a longitudinal center portion of the bottom surface of the elongated lens 302 and supports the elongated lens unit 3 against the biasing forces applied from the flat springs is arranged below the elongated lens unit 3. The fulcrum (not shown) serving as a support unit is arranged in a manner to project from a bottom surface of the optical housing 400 and has a semi-cylindrical shape (a vault shape).

A skew adjusting mechanism 10 serving as a position limiter which limits the position of a longitudinal one end of the elongated lens unit 3 against the biasing force applied from the first flat spring 7 is arranged at a longitudinal one end portion of the elongated lens unit 3. The skew adjusting mechanism 10 and the fulcrum (not shown) are in contact with the elongated lens unit against the biasing forces applied from the first and second flat springs 7 and 8. Accordingly, the elongated lens unit 3 is vertically sandwiched and held between the flat springs 7 and 8, and the skew adjusting mechanism 10 and the fulcrum (not shown) to thus be held by the optical housing 400.

FIG. 10A is a perspective view of the skew adjusting mechanism 10. FIG. 10B is a cross-sectional view of the skew adjusting mechanism 10. The skew adjusting mechanism 10 includes a drive motor 10a, a drive motor holder 10b, and an adjuster 10c. An output shaft of the drive motor 10a has a threaded portion, onto which the adjuster 10c is fixed by screwing. The adjuster 10c is D-shaped in cross section and inserted into a D-shaped adjuster slot 10b1 defined in the drive motor holder 10b. With this structure, the adjuster slot 10b1 limits rotational motion of the adjuster 10c. Accordingly, even when the output shaft of the drive motor 10a rotates, the adjuster 10c is not rotated, but the adjuster 10c is screw-fed to ascend or descend in the direction indicated by an arrow C in FIG. 10B. The drive motor holder 10b is fixed onto the optical housing 400 with a screw so that a distal end of the adjuster 10c of the skew adjusting mechanism 10 contacts one end of the elongated-lens facing surface of the top surface portion 2a of the bracket 2. The drive motor 10a is a pulse-driven stepping motor.

Adjusting the scan line tilt is performed not only before shipment of the printer but also at predetermined events including, for example, an event triggered when the number of sheets printed by the printer reaches a predetermined number, when a user instruction is received, or when an output of a temperature sensor reaches a pre-set temperature. How to adjust the scan line tilt is specifically described below.

When adjusting the scan line tilt, the printer forms latent images of predetermined tilt-adjusting patterns on the photoconductive drums 501, 502, 503, 504 (Y, M, C, and Bk) by performing the same operation as in the normal image formation. The latent images of the predetermined tilt-adjusting patterns are developed as in the normal image formation to obtain tilt-adjusting patterns (toner images). The tilt-adjusting patterns are then transferred onto the intermediate transfer belt 606. Thereafter, a pattern sensor (optical sensor) (not shown) detects the tilt-adjusting patterns of the respective colors transferred onto the intermediate transfer belt 606. Amounts of misregistration between the tilt-adjusting pattern for black (Bk) and each of the tilt-adjusting patterns for the other colors (Y, C, and M) are obtained based on detection results output from the pattern sensor. A scan line tilt which minimizes the thus-obtained amount of misregistration with respect to the tilt-adjusting pattern for black (Bk) is calculated for each of the other colors (Y, C, and M). Tilts obtained as calculation results are fed to a control unit (not shown) serving an orientation adjusting unit. The control unit controls the rotation angle of the drive motor 10a according to the calculation results. As a result, the adjuster 10c attached to the rotary shaft of the drive motor 10a ascends or descends in the direction in which the first flat spring 7 is biased or released, causing the one end of the elongated lens unit 3 to move in a corresponding one of the directions indicated by arrow D in FIG. 9. More specifically, as the adjuster 10c ascends, the position to which the one end of the elongated lens unit 3 is limited ascends. As this position ascends, the one end of the elongated lens unit 3 ascends against the biasing force applied from the first flat spring 7 (that is, the one end moves in the direction opposite to the biasing direction of the first flat spring 7). As a result, the elongated lens unit 3 changes its orientation by pivoting clockwise in FIG. 9 on the fulcrum (not shown). On the other hand, as the adjuster 10c descends, the position to which the one end of the elongated lens unit 3 is limited descends. As this position descends, the one end of the elongated lens unit 3 is lowered by the biasing force applied from the first flat spring 7 (that is, the one end moves in the biasing direction of the first flat spring 7). As a result, the elongated lens unit 3 changes its orientation by pivoting counterclockwise in FIG. 9 on the fulcrum (not shown).

When the orientation of the elongated lens unit 3 changes in this manner, the position where the laser beam is incident on the plane of incidence of the elongated lens 302 changes. The elongated lens 302 of the present embodiment has the following characteristics. When the position where a laser beam L is incident on the plane of incidence of the elongated lens 302 changes, an angle (exit angle) of the laser beam exiting from the exiting plane of the elongated lens 302 with respect to the vertical direction changes. More specifically, the incident position, at which the laser beam L is incident on the plane of incidence of the elongated lens 302, changes toward the direction (vertical direction) orthogonal to the longitudinal direction of the elongated lens 302 and to the optical path. This characteristics cause, when the orientation of the elongated lens unit 3 is changed by the adjuster 10c, the exit angle of the laser beam exiting from the exiting plane of the elongated lens 302 to change in response thereto. As a result, the scan line tilt of the laser beam scanning the surface of the photoconductive drum changes.

FIG. 11 is an enlarged view of a longitudinal other end portion of the scan-line adjusting device 1.

As shown in FIG. 11, in the embodiment, a vibration damping member 20 configured to damp vibrations transmitted from the second flat spring 8 to the elongated lens unit 3 is arranged between the smooth-surface member 6b and the bracket 2.

The color printer 500 of the embodiment is configured in such a manner that the intermediate transfer belt 606 can be brought into contact with or separated from the photoconductive drums 501, 502, 503 (Y, M, and C) for the colors. When forming a black-and-white image, image formation is performed with the photoconductive drums 501, 502, and 503 for the colors retracted from the intermediate transfer belt 606. This configuration allows stopping the image stations (the Y, M, and C image stations) for the colors, thereby lengthening usable lives of the Y, M, and C image stations. Furthermore, because wear of the intermediate transfer belt 606 resulting from friction with the photoconductive drums 501, 502, and 503 for the colors is also prevented, usable life of the intermediate transfer belt 606 can also be increased. The paper feeding roller 608 is normally positioned away from a recording paper bundle in the paper feeding cassette. The paper feeding roller 608 is brought into contact with an uppermost sheet of the recording paper bundle in the paper feeding cassette when the uppermost sheet is to be conveyed to the pair of registration rollers 609.

When the intermediate transfer belt 606 reaches and stops at a position separated from the photoconductive drums 501, 502, and 503 for the colors, an impact is produced. An impact is produced also when the intermediate transfer belt 606 contacts the photoconductive drums 501, 502, and 503 for the colors. An impact is produced also when the paper feeding roller 608 contacts the recording paper bundle. Each of components of the color printer 500 may vibrate at its natural frequency when such an impact is applied. Vibrations generated by the components of the color printer 500 are transmitted to the optical housing 400 of the optical scanning device 100 via a frame of the color printer 500 or the like. Vibrations of the members transmitted to the optical housing 400 are further transmitted via members fixed to the optical housing 400 of the scan-line adjusting device 1 to the elongated lens unit 3. Among the vibrations of the members transmitted to the elongated lens unit 3, vibration(s) whose frequency is close to the natural frequency of the elongated lens unit 3 triggers resonance in the elongated lens unit 3, causing the elongated lens unit 3 to vibrate greatly. As a result, a position where the photoconductive drum is irradiated with light can be displaced in the sub-scanning direction at the natural frequency of the elongated lens unit 3, resulting in a defective image having banding or the like.

Examples of a possible method for reducing vibration of the elongated lens unit 3 include a method of increasing rigidity of the elongated lens unit 3 by attaching a reinforcing plate to the bracket 2, thereby making the natural frequency of the elongated lens unit 3 different from frequencies of the vibrations transmitted to the elongated lens unit 3. However, the frequencies of the vibrations transmitted to the elongated lens unit 3 are the natural frequencies of the members of the color printer 500 generated by the impact described above and what is generally referred to as white noise containing all frequency components with flat spectral density. Accordingly, it is substantially unattainable to make the natural frequency of the elongated lens unit 3 different from the frequencies of the vibrations transmitted to the elongated lens unit 3, and one of the frequencies transmitted to the elongated lens unit 3 will undesirably trigger resonance in the elongated lens unit 3.

The applicant of the present invention has studied how the elongated lens unit 3 vibrates and found that the other end portion (on the side contacting the second flat spring 8) of the elongated lens unit 3 vibrates greatly. This is because there is a gap between the other end portion, which is on the side opposite from the one end portion and with which the second flat spring 8 is in contact, of the elongated lens unit 3 and the optical housing 400. This gap allows the other end of the elongated lens unit to move freely downward to some extent in FIG. 9. Transmission of vibrations from the optical housing 400 to the elongated lens unit 3 occurs as transmission via the members attached to the optical housing 400 of the scan-line adjusting device 1. More specifically, the vibrations are transmitted via the skew adjusting mechanism 10, the first flat spring 7, and the second flat spring 8. Because of being configured to be freely movable to some extent, the other end portion is prone to vibrate, and vibrated greatly at its resonance triggered by the vibrations in white noises transmitted from the second flat spring 8. By contrast, the one end portion of the elongated lens unit 3 is sandwiched and held between the first flat spring 7 and the skew adjusting mechanism 10. Accordingly, the one end portion does not vibrate greatly even when vibrations are transmitted to the one end portion from the first flat spring 7 and the skew adjusting mechanism 10.

In view of the above, in the present embodiment, a vibration damping member 20 is arranged on the other end portion of the elongated lens unit 3 as illustrated in FIG. 11. As the vibration damping member 20, a rubber damper which is a member having viscosity to absorb vibrations can be used, for example. Adding the vibration damping member 20 such as the rubber damper enable to absorb vibration energy transmitted from the second flat spring 8 and damp the vibrations. Accordingly, the vibration damping member 20 is able to reduce undesirable large vibrations of the other end of the elongated lens unit 3 which is caused by vibrations transmitted from the second flat spring 8. As a result, banding in an image resulting from vibrations of the elongated lens unit 3 can be reduced.

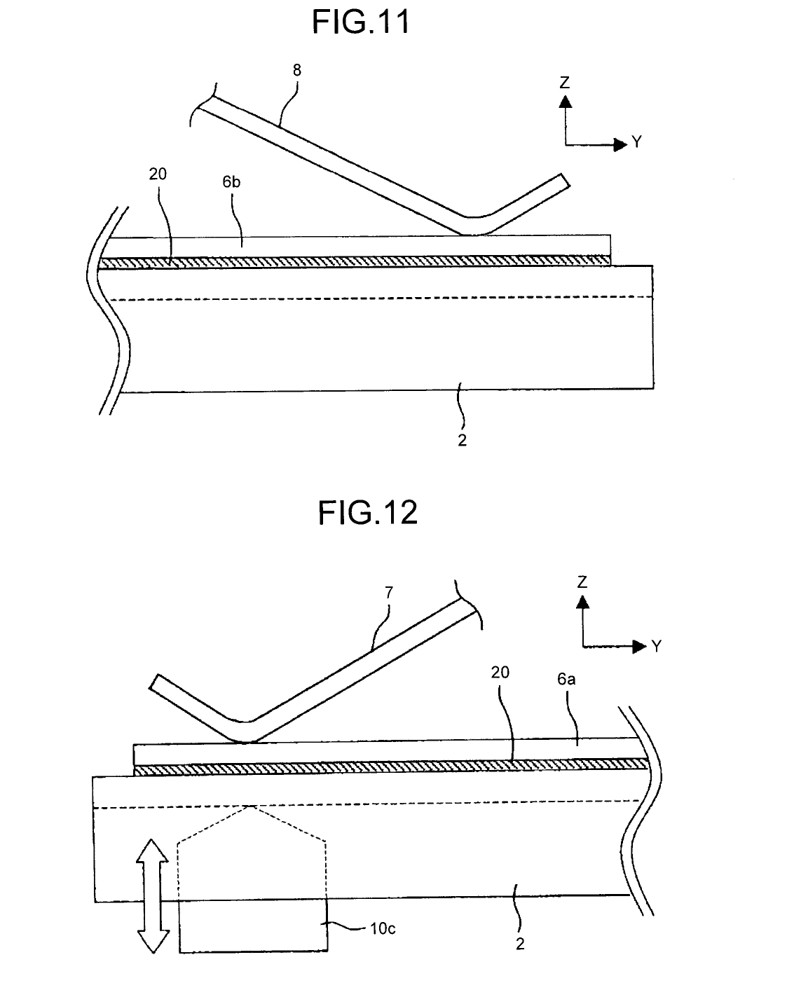

FIG. 12 is an enlarged view of the one end portion of the scan-line adjusting device 1.

The vibration damping member 20 may be arranged also on the one end portion at a position between the smooth-surface member 6a and the bracket 2 as illustrated in FIG. 12 as is arranged on the other end portion. With this configuration, the vibrations transmitted from the first flat spring 7 are damped with the vibration damping member 20, causing the damped vibrations to be transmitted to the one end of the elongated lens unit 3. As a result, vibrations of the elongated lens unit 3 can be further reduced. A vibration damping member may be added to between the drive motor holder 10b and the drive motor 10a of the skew adjusting mechanism 10, for example. Adding the vibration damping member to between the drive motor holder 10b and the drive motor 10a enable to damp the vibrations transmitted from the drive motor holder 10b fixed to the optical housing 400, thereby causing the damped vibrations to be transmitted to the drive motor 10a. Because vibrations of the drive motor 10a are reduced in this manner, vibrations transmitted from the adjuster 10c fixed by screwing onto the output shaft of the drive motor 10a to the elongated lens unit 3 can be reduced. As a result, vibrations of the elongated lens unit 3 can be further reduced. A vibration damping member may be added to between the adjuster 10c and the bracket 2. This configuration also enable to reduce vibrations transmitted from the adjuster 10c to the elongated lens unit 3.

There may be a situation where the elongated lens unit 3 is pivoted with respect to the main-scanning direction (the pivoting direction in FIG. 9) against the biasing force applied from the flat spring 7, 8 by an impact or vibrations applied during conveyance of the color printer 500 or conveyance of the optical scanning device 100. In such a situation, if the static frictional force between the flat spring 7, 8 and the elongated lens unit 3 is large, the flat spring 7, 8 will not slide with respect to the elongated lens unit 3 at a contact position therebetween. This can result in that the contact position moves in a manner to follow the elongated lens unit 3, undesirably causing the flat springs to be distorted with respect to the main-scanning direction. As a result, the biasing directions of the flat springs 7 and 8 are tilted relative to the sub-scanning direction. In this state, it is possible that the elongated lens unit 3 does not return to its original orientation but be held in the tilted orientation pivoted with respect to the main-scanning direction. If the elongated lens unit 3 tilts with respect to the main-scanning direction in this manner, the functions of correcting the scan line tilt and correcting the curvature are undesirably impaired. Furthermore, the tilt can also impair beam pitch interval characteristics and result in a defective image.

Occurrence of the above-described problem can be reduced by decreasing the static frictional force by decreasing the biasing forces applied from the flat springs, so that the flat springs 7 and 8 can slide smoothly relative to the elongated lens unit 3. However, decreasing the biasing forces applied from the flat springs 7 and 8 is disadvantageous in that the elongated lens unit 3 becomes more apt to vibrate, making an image vulnerable to a defect such as banding. In particular, in the embodiment, the vibration damping member 20 such as the rubber damper is added to between the flat springs 7 and 8, and the elongated lens unit 3. Therefore, if the flat springs 7 and 8 and the vibration damping member 20 formed of rubber are in direct contact with each other, the frictional force therebetween is higher than the frictional force between the bracket 2 and the flat springs contacting each other. Accordingly, the problem that the elongated lens unit 3 does not return to its original orientation is more likely to occur.

However, as described above, the scan-line adjusting device 1 according to the present embodiment includes the smooth-surface members 6a and 6b, with which the first and second flat springs 7 and 8 are in contact respectively. A static friction coefficient between the smooth-surface member 6a and the flat spring 7 and that between the smooth-surface member 6b and the flat spring 8 are lower than a static friction coefficient between the bracket 2 and each of the flat springs 7 and 8. This makes the flat springs 7 and 8 be more likely to slide relative to the elongated lens unit 3 than in the structure in which the flat springs 7 and 8 are in contact with the bracket 2. Accordingly, when the elongated lens unit 3 is pivoted with respect to the main-scanning direction, the flat spring 7, 8 slides relative to the elongated lens unit 3, thereby limiting a change in the biasing directions of the flat springs 7 and 8. As a result, the elongated lens unit 3 that is pivoted can be returned to its original orientation with the biasing force of the flat springs 7 and 8. Accordingly, an undesirable situation that an impact applied during conveyance of the color printer 500 or the optical scanning device 100 impairs the functions of correcting the scan line tilt and correcting the curvature can be prevented, and the surface of the photoconductive drum can be scanned favorably. Furthermore, the beam pitch interval characteristics also remain unchanged. This leads to reducing a defective image resulting from an impact applied during conveyance of the color printer 500 or the optical scanning device 100.

The smooth-surface members 6a and 6b are preferably metal members so that contact surfaces, at which the flat springs contact, of the smooth-surface members 6a and 6b can be formed as smooth surfaces by grinding easily. The smooth-surface members may alternatively be formed from a resin, such as polyacetal (POM), polyamide (PA), or polytetrafluoroethylene (PTFE), which exhibits high sliding property.

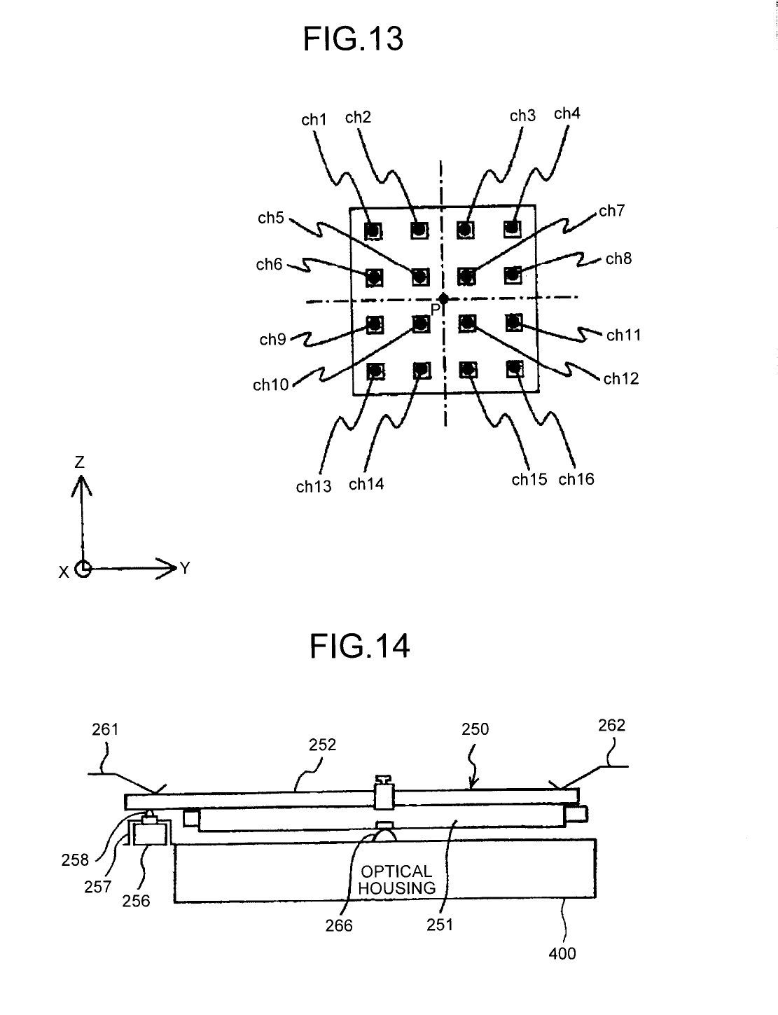

In the present embodiment, such a surface-emitting light source as that illustrated in FIG. 13 in which multiple light-emitting elements are arranged in a 4×4 array in a plane perpendicular to the direction in which light beams are emitted is employed as the light source 102. Using a surface-emitting light source as the light source 102 makes printing with higher resolution possible. Alternatively, in place of the surface-emitting light source, an LD (laser diode) including a single light-emitting element or an LD array including multiple light-emitting elements arranged linearly or two-dimensionally may be used. Using such a light source makes printing with higher resolution possible as well. However, the surface-emitting light source is more effective in cost reduction and more preferable.

The embodiment described above is merely an example and each of the following aspects of the present invention offers a particular advantage.

### First Aspect

According to a first aspect, the scan-line adjusting device 1 includes a first biasing unit such as the first flat spring 7, configured to apply a biasing force in biasing/releasing directions to and from a longitudinal one end of an optical unit, which may be embodied as the elongated lens unit 3, arranged on an optical path from the light source 102 in the optical scanning device 100 to a to-be-scanned subject, such as the photoconductive drum 504, a second biasing unit such as the second flat spring 8 configured to apply a biasing force in the same biasing direction as that of the first biasing unit to a longitudinal other end of the optical unit, a support unit such as the fulcrum configured to support the optical unit at a position between, in the longitudinal direction of the optical unit, a position where the biasing force is applied from the first biasing unit and a position where the biasing force is applied from the second biasing unit in a manner that allows the optical unit to pivot against the biasing force applied from the biasing unit, a position limiter such as the skew adjusting mechanism 10 configured to limit a position of the longitudinal one end of the optical unit against the biasing force applied from the first biasing unit to a limit position and be capable of changing the limit position of the longitudinal one end of the optical unit in the biasing direction of the first biasing unit, and the scan-line adjusting device 1 includes the vibration damping member 20 configured to damp vibrations transmitted from the second biasing unit to the optical unit.

The applicant of the present invention has studied vibrations of the optical unit such as the elongated lens unit 3 extensively and found that the longitudinal other end portion where the biasing force is applied from the second biasing unit such as the second flat spring 8, of the optical unit vibrates greatly. The applicant considers the following is the reason why the other end portion of the optical unit vibrates greatly. Transmission of vibrations from the optical housing 400 to the optical unit presumably occurs as transmission from members such as the position limiter, the first biasing unit such as the first flat spring 7, and the second biasing unit attached to the optical housing 400. Meanwhile, the optical unit is simply put on a top portion of the support unit. Accordingly, the applicant considers transmission of vibrations from the support unit mounted on the optical housing 400 as negligible. The one end portion of the optical unit is sandwiched and held between the first biasing unit and the position limiter; this is possibly the reason why the one end portion of the optical unit does not vibrate greatly even when vibrations are transmitted from the first biasing unit or the position limiter to the one end. Meanwhile, there is the gap between the longitudinal other end portion of the optical unit and the optical housing so that the optical unit can pivot on the fulcrum when the one end of the optical unit is pressed toward the first biasing unit by the position limiter. This is possibly the reason why the other end portion of the optical unit vibrates greatly as compared with other portions when vibrations are transmitted from the second biasing unit to the other end portion.

In view of the circumstances, the scan-line adjusting device according to the first aspect includes the vibration damping member configured to damp vibrations transmitted from the second biasing unit to the optical unit. The vibration damping member prevents the other end portion of the optical unit from being vibrated greatly by vibrations transmitted from the second biasing unit, thereby reducing occurrence of a defective image having banding or the like.

### Second Aspect

According to a second aspect, the scan-line adjusting device according to the first aspect further includes the vibration damping member 20 configured to damp vibrations transmitted from the first biasing unit to the optical unit.

According to the second aspect, vibrations transmitted from the first biasing unit such as the first flat spring 7 can be reduced, and vibrations of the optical unit such as the elongated lens unit 3 can be further reduced.

### Third Aspect

According to a third aspect, in the scan-line adjusting device according to the first aspect, the first biasing unit such as the first flat spring 7 and the second biasing unit such as the second flat spring 8 are configured to be brought into contact with the smooth-surface members 6a and 6b and apply the first and second biasing forces to the optical unit, which may be embodied as the elongated lens unit 3, via the smooth-surface members 6a and 6b.

According to the third aspect, the biasing units such as the flat springs 7 and 8, are more likely to slide than in a configuration in which the biasing units are brought into direct contact with the optical unit such as the elongated lens unit 3. Accordingly, if the optical unit should be pivoted by an impact applied during conveyance of the optical scanning device 100 or the like in a manner that differs from the optical unit pivoted to adjust the scan line tilt, the biasing units slide on the smooth-surface members 6a and 6b, thereby limiting a change in orientation of the optical unit. Accordingly, even when the optical unit is pivoted in a manner that differs from the optical unit pivoted to adjust the scan line tilt, the biasing forces can be applied in a predetermined direction and the optical unit can return to its original orientation by the biasing forces applied from the biasing units. Thus, an undesirable situation that the function of adjusting the scan line is impaired by an impact applied during conveyance of the optical scanning device 100 or the like is limited, and favorable images can be maintained.

### Fourth Aspect

According to a fourth aspect, in the scan-line adjusting device according to the third aspect, a friction coefficient of contact surfaces, at which the biasing units such as the flat springs contact, of the smooth-surface members is lower than a friction coefficient of a surface of a holding member such as the bracket 2, which holds an optical components including the elongated lens 302 of the optical unit such as the elongated lens unit 3.

According to the fourth aspect, the static frictional force between the optical unit and the biasing units can be reduced as compared a configuration in which the smooth-surface members are not interposed between the optical unit such as the elongated lens unit 3, and the biasing units such as the flat springs.

### Fifth Aspect

According to a fifth aspect, in the scan-line adjusting device according to the third aspect or the fourth aspect, the smooth-surface members are metal members.

According to the fifth aspect, because the smooth-surface members are metal members, the contact surfaces, at which the biasing units such as the flat springs contact, of the smooth-surface members can be smoothed easily by grinding or the like.

### Sixth Aspect

According to a sixth aspect, in the scan-line adjusting device according to the first to fifth aspects, the optical unit such as the elongated lens unit 3 includes the elongated lens 302.

According to the sixth aspect, the scan line tilt can be adjusted by pivoting the elongated lens 302 with respect to the direction of the optical axis using the position limiter such as the skew adjusting mechanism 10. Furthermore, curvature of the scan line can also be adjusted by causing the elongated lens unit 3 to curve by pressing a longitudinal center portion of the elongated lens unit 3 in the sub-scanning direction.

### Seventh Aspect

According to a seventh aspect, in the scan-line 1 adjusting device according to the first to sixth aspects, the vibration damping member 20 is a member, such as a rubber damper, which absorbs vibration.

According to the seventh aspect, vibrations of the second biasing unit such as the second flat spring 8 are damped and then transmitted to the optical unit such as the elongated lens unit 3. Accordingly, the vibrations of the optical unit can be reduced.

### Eighth Aspect

According to an eighth aspect, the optical scanning device 100 includes the light source 102, and a scanning unit such as the deflector 202 configured to irradiate and scan a to-be-scanned subject, which may be embodied as the photoconductive drum 504, with light emitted from the light source 102, and the scan-line adjusting device according to any one of the first to seventh aspects as the scan-line adjusting device 1 arranged on an optical path from the scanning unit to the to-be-scanned subject and configured to adjust a scan line.

According to the eighth aspect, it is possible to adjust the scan line to a predetermined position of the to-be-scanned subject such as the photoconductive drum 504.

### Ninth Aspect

According to a ninth aspect, in the optical scanning device according to the eighth aspect, a light source including multiple light-emitting elements is used as the light source 102.

According to the ninth aspect, as described above in the embodiment, printing can be performed at higher resolution.

### Tenth Aspect

According to a tenth aspect, in the optical scanning device according to the ninth aspect, a surface-emitting laser is used as the light source 102.

According to the tenth aspect, as described above in the embodiment, printing can be performed at higher resolution.

### Eleventh Aspect

According to an eleventh aspect, an image forming apparatus includes the optical scanning device according to any one of the eighth to tenth aspects, a photoconductor to be scanned by the optical scanning device with scanning light representing image information to form a latent image on the photoconductor, a developing device configured to develop the latent image to obtain an image, and a transfer unit configured to transfer the image onto a recording material to thereby form the image on the recording material.

This configuration allows enable to limit production of a defective image having banding or the like.

According to an aspect of the present invention, vibrations of an optical unit can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A scan-line adjusting device comprising:
a first biasing unit configured to apply a first biasing force in biasing direction to a longitudinal one end of an optical unit arranged on an optical path from a light source to a to-be-scanned subject;
a second biasing unit configured to apply a biasing force in the biasing direction to a longitudinal other end of the optical unit, the biasing direction being same as that of the first biasing unit;
a support unit configured to support the optical unit at a position between, in the longitudinal direction of the optical unit, a position where the biasing force is applied from the first biasing unit and a position where the biasing force is applied from the second biasing unit in a manner that allows the optical unit to pivot against the biasing force applied from the biasing unit;
a position limiter configured to limit a position of the longitudinal one end of the optical unit against the biasing force applied from the first biasing unit to a limit position and be capable of changing the limit position of the longitudinal one end of the optical unit in the biasing direction of the first biasing unit; and
a vibration damping member configured to damp vibration transmitted from the second biasing unit to the optical unit.

2. The scan-line adjusting device according to claim 1, further comprising a vibration damping member configured to damp vibration transmitted from the first biasing unit to the optical unit.

3. The scan-line adjusting device according to claim 1, further comprising
a smooth-surface member, wherein
the first biasing unit and the second biasing unit are configured to be brought into contact with the smooth-surface member and apply the biasing force to the optical unit via the smooth-surface member.

4. The scan-line adjusting device according to claim 3, wherein
the optical unit includes an optical component and a holding member configured to hold the optical component, and
a friction coefficient of a contact surface, at which the biasing units contact the smooth-surface member, of the smooth-surface member is lower than a friction coefficient of a surface of the holding member.

5. The scan-line adjusting device according to claim 3, wherein the smooth-surface member is a metal member.

6. The scan-line adjusting device according to claim 1, wherein the optical unit includes an elongated lens.

7. The scan-line adjusting device according to claim 1, wherein the vibration damping member is a member which absorbs vibration.

8. An optical scanning device comprising:
a light source;
a scanning unit configured to irradiate and scan a to-be-scanned subject with light emitted from the light source; and
a scan-line adjusting device arranged on an optical path from the scanning unit to the to-be-scanned subject and configured to adjust a scan line, wherein
the scan-line adjusting device is the scan-line adjusting device according to claim 1.

9. The scan-line adjusting device according to claim 8, wherein a light source including multiple light-emitting elements is used as the light source.

10. The scan-line adjusting device according to claim 9, wherein a surface-emitting laser is used as the light source.

11. An image forming apparatus comprising:
the optical scanning device according to claim 8;
a photoconductor scanned by the optical scanning device with scanning light representing image information to form a latent image thereon;
a developing device configured to develop the latent image to obtain an image; and
a transfer unit configured to transfer the image onto a recording material to thereby form the image on the recording material.
